(19) United States
(12) Patent Application Publication
(10) Pub. No.: US 2012/0006271 A1
(43) Pub. Date: Jan. 12, 2012

(54) Pet Swing

(76) Inventors: Djauna Van Dine, Pikeville, KY (US); Tony Van Dine, Pikeville, KY (US)

(21) Appl. No.: 13/168,737

(22) Filed: Jun. 24, 2011

Related U.S. Application Data
(60) Provisional application No. 61/362,774, filed on Jul. 9, 2010.

(51) Int. Cl. A01K 29/00

(52) U.S. Cl. 119/28.5

(57) ABSTRACT

A pet swing set for pets. The pet swing set includes a horizontal bar supported with four foldable legs, a seat that is hung from the horizontal bar by a set of strings, rods or chains with matching pattern. A grooming means for pets is removably fixed on the seat. A stepping structure is disposed between the seat and ground, to provide stability and access to the pet swing.

### REFERENCE TO RELATED APPLICATIONS

This patent application claims the benefit of U.S. Provisional Application No. 61/362,774 filed on Jul. 9, 2010, the disclosure of which is incorporated herein by reference in its entirety.

### BACKGROUND OF THE INVENTION

### Description of Related Art

The present application relates to a pet swing, and more particularly to a swing bed that accommodates the needs of a pet.

Note that the points discussed below may reflect the hindsight gained from the disclosed inventions, and are not necessarily admitted to be prior art.

Traditional pet beds have a base and a continuous side wall that is attached to the base forming a soft tray on the ground. Many pets, however, have a tendency to jump up on the couch to stretch out and relax. Pet owners often are annoyed when the pets leave dirty footprints, hair, drools, scratch marks on the furniture.

A pet swing may allure a pet away from the furniture and be preferred as bed by a pet. Swing chairs designed for human use requires complicated mounting and strong holdings for safety reasons. For example, U.S. Pat. No. 6,951,369 B1 describes a swing chair that includes multiple rods, racks and connecting points in supporting the swing chair, and the parts are mounted together with various nuts and bolts. These high safety requirements in design and in material and quality increase manufacturing cost, thus not suitable for pet market.

### SUMMARY

The present application discloses new approaches to a pet swing that accommodates the needs of a pet, yet sufficiently simple for reduced cost in manufacturing.

In one embodiment, four straight legs form two supporting triangular racks on the left and right side of a swing, on each side the legs can fold into one another. The legs lock once unfolded by a simple notch rod that clicks into place between two side legs. And a top traverse rod is disposed between the triangular racks.

In one aspect of an embodiment, a pet swing similar in shape to a bench swing is tied on the top traverse rod by strings or ropes that are sufficiently strong to hold the pet swing. The strings or ropes may be fixedly sewed on to edge of the bench back. The strings or ropes may also simply form two loops that allow the pet swing to be placed into and hung on the top traverse rod.

In one embodiment, the pet swing is cushioned with foam material underneath a layer of textile material.

In one embodiment, a pet grooming pillow is tightly held onto the bed base for not to be easily displaced by a pet.

In one embodiment, a step like structure is inserted into a slot on the front lip of the bench, which provides further stability for the pet swing, and a stepping-on for a pet to access the pet swing.

The disclosed pet swing provides the comfort and style that accommodates a pet's need to stay off the ground, and also provides a pet owner an easy way to adore a pet in style with a reasonable cost.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1A shows a perspective view of an example pet swing in accordance with this application.

FIG. 1B shows a sections view of an example step structure in accordance with this application.

FIG. 2 shows a perspective view of another example pet swing in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

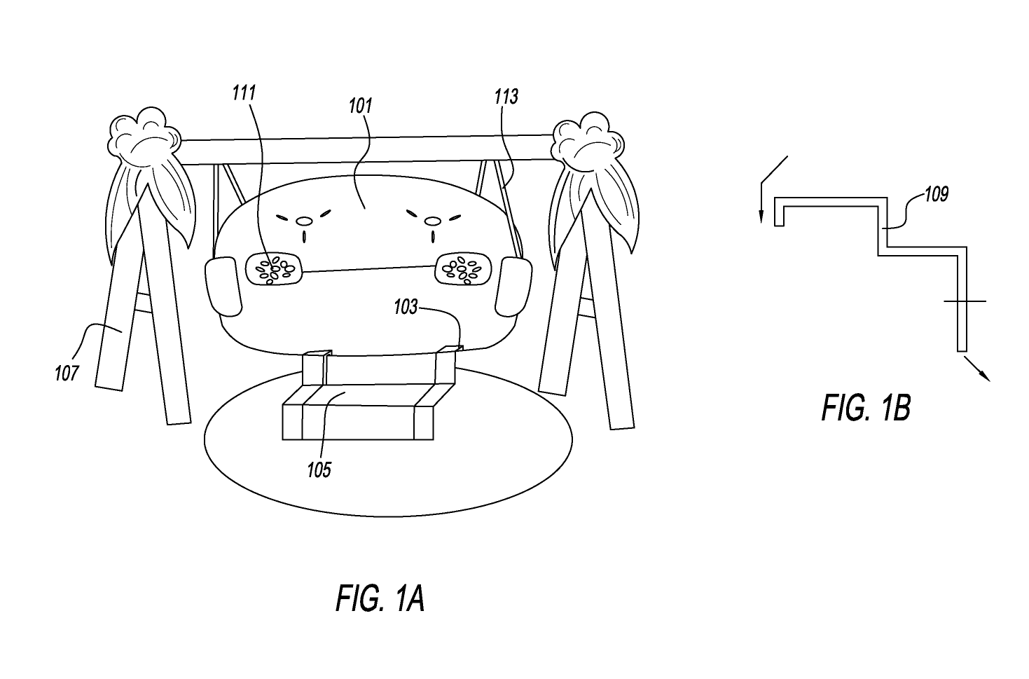

In reference to FIGS. 1A and 1B, a pet swing for animal pets includes a four leg rack 107, a swing bench bed 103 having a chair back 101, a step 105 that inserts into a slot of the front lip of bench bet 103, animal grooming means 111.

Rack 107 includes two supporting triangular racks formed by four straight legs, and the legs can fold into one another. The legs lock once unfolded by a simple notch rod that clicks into place between two side legs. And a top traverse rod is disposed between the triangular racks. The triangular racks and a top traverse rod form a horizontal bar like structure for supporting the pet swing.

Pet swing 103 similar in shape to a bench swing is tied on the top traverse rod by string or rope 113, that are sufficiently strong to hold the pet swing 103. String or rope 113 may be fixedly sewed onto edge of swing back 101. The string or rope 113 may also is detached from the pet swing 103, is independently tied to the horizontal bar, and simply forms two loops that allow the pet swing 103 to be placed into and hung on the top traverse rod.

Pet swing 103 may be cushioned with foam material underneath a layer of textile material, or just made of plastic or metal material, covered with textiles. Pet grooming means 111, for example a pair of pillows may be tightly held onto the bed base by pre-sewn on strings so that they may not to be easily taken off by a pet.

Step like structure 105 is inserted into a slot on the front lip of the pet swing, which provides further stability for the pet swing, and a stepping-on step for a pet to access the pet swing. Step 101 is shown in FIG. 1B as step 109 which includes a rubber sleeve structure for the bottom of the step for holding firm to the floor. Step 109 also includes a lip structure at the top level which can slide into front of the seat of the pet swing for holding the swing bed steady.

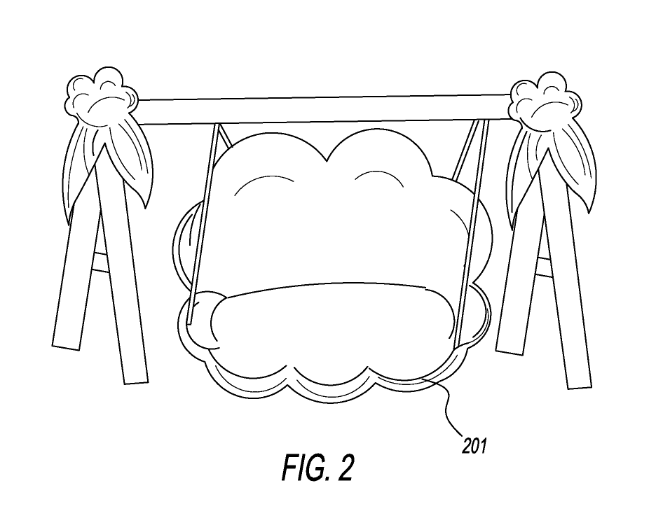

In reference to FIG. 2, pet swing 201 may be designed as a dog paw or cat paw for style with the hanging string one attached to the seat base the other end to the seat back. The pattern of the cover material may also be changed to match the taste of the pet owner.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A pet swing for pets, comprising:
a horizontal bar having two legs at left side and right side;
a seat sized for a pet to sleep on;
a string, chain or rod having matching style to said seat, hanging said seat to said horizontal bar; and
a grooming means removably fixed on said seat.

2. The pet swing of claim 1, further comprising:
a stepping structure fixedly disposed to said seat and floor, thereby stabilizing said seat.

3. The pet swing of claim 1, wherein said seat is styled as an animal paw.

4. The pet swing of claim 1, wherein said seat is styled as a cat or dog paw.

5. The pet swing of claim 1, wherein said legs are foldable.

6. The pet swing of claim 1, wherein said seat is made of plastic.

7. The pet swing of claim 1, wherein said seat is made of metal, plastic or wood
